(19) United States
(12) Patent Application Publication
(10) Pub. No.: US 2023/0170134 A1
(43) Pub. Date: Jun. 1, 2023

(54) COIL COMPONENT

(71) Applicant: SAMSUNG ELECTRO-MECHANICS CO., LTD., Suwon-si, Gyeonggi-do (KR)

(72) Inventors: Jong Ok JEON, Suwon-si (KR); Hyo Ki HONG, Suwon-si (KR); In Young KANG, Suwon-si (KR); Young Seuck YOO, Suwon-si (KR)

(73) Assignee: SAMSUNG ELECTRO-MECHANICS CO., LTD., Suwon-si, Gyeonggi-do (KR)

(21) Appl. No.: 17/985,353

(22) Filed: Nov. 11, 2022

(30) Foreign Application Priority Data
Nov. 26, 2021 (KR) 10-2021-0165732

(51) Int. Cl. H01F 27/29; H01F 27/02; H01F 27/24; H01F 1/20

(52) U.S. Cl. CPC H01F 27/292; H01F 27/022; H01F 27/24; H01F 1/20

(57) ABSTRACT

A coil component includes a body including a molded portion including a first magnetic metal particle and a cover portion disposed on one surface of the molded portion and including a second magnetic metal particle; and a coil portion disposed between the one surface of the molded portion and the cover portion and embedded in the body, wherein at least one of the first and second magnetic metal particles includes first to third particles having different medians (d50) of particle sizes.

### CROSS-REFERENCE TO RELATED APPLICATION

This application claims benefit of priority to Korean Patent Application No. 10-2021-0165732 filed on Nov. 26, 2021 in the Korean Intellectual Property Office, the disclosure of which is incorporated herein by reference in its entirety.

### TECHNICAL FIELD

The present disclosure relates to a coil component.

### BACKGROUND

The current development direction of power inductors is to realize low resistance, high DC-bias characteristics, and high efficiency characteristics. To this end, magnetic metal particles used in a body of the power inductors have been developed to realize miniaturization, high filling, and low loss. In order to realize high efficiency characteristics, development has been conducted to reduce a size of powder particles as a material and reduce a coercive force of the material itself to reduce loss.

In particular, in the case of wire-wound power inductors, a technology of securing magnetic permeability through high filling using plastic deformation of powder particles used in a body by pressing at high pressure during mold forming is applied. A structure of a product using the technology uses two types of layers of a cover portion formed at a relatively low pressure after arrangement of a core portion and a coil portion formed at a high pressure or a cover portion formed at a relatively high pressure after arrangement of a core portion and a coil portion formed at low pressure. In this case, materials of the core portion and the cover portion may be different.

### SUMMARY

An aspect of the present disclosure may provide a coil component in which a body of a coil component having a low thickness is formed without destroying the body.

An aspect of the present disclosure may also provide a coil component in which a body is formed even at low pressure.

An aspect of the present disclosure may also provide a coil component in which a filling rate of magnetic particles in a body is secured even at low pressure.

According to an aspect of the present disclosure, a coil component includes a body including a molded portion including a first magnetic metal particle and a cover portion disposed on one surface of the molded portion and including a second magnetic metal particle, and a coil portion disposed between the one surface of the molded portion and the cover portion and embedded in the body, wherein at least one of the first and second magnetic metal particles includes first to third particles having different median particle sizes.

According to another aspect of the present disclosure, a coil component includes a body including a molded portion including a first magnetic metal particle and a cover portion disposed on one surface of the molded portion and including a second magnetic metal particle, and a coil portion disposed between the one surface of the molded portion and the cover portion and embedded in the body, wherein at least one of the first and second magnetic metal particles includes first to third particles having different median particle sizes and the other includes the first and second particles.

According to another aspect of the present disclosure, a coil component includes a body including a molded portion including a first magnetic metal particle and a cover portion disposed on one surface of the molded portion and including a second magnetic metal particle, wherein the first magnetic metal particle is different from the second magnetic metal particle, the first magnetic metal particle or the second magnetic metal particle includes first to third particles having different medians (d50) of particle sizes, and the other magnetic metal particle includes the first and second particles; and a coil portion disposed between the one surface of the molded portion and the cover portion and embedded in the body.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a view schematically illustrating a coil component according to a first exemplary embodiment in the present disclosure;

FIG. 2 is an exploded perspective view of FIG. 1;

FIG. 3 is a cross-sectional view of a coil component according to the first exemplary embodiment taken along line I-I′ of FIG. 1;

FIG. 4 is a cross-sectional view of a coil component according to a second exemplary embodiment in the present disclosure taken along line I-I′ of FIG. 1;

FIG. 5 is an enlarged cross-sectional view illustrating magnetic metal particles applied to the first and second exemplary embodiments of the present disclosure;

FIG. 6 is a view schematically illustrating a coil component according to a third exemplary embodiment in the present disclosure; and

FIG. 7 is a view schematically illustrating a coil component according to a fourth exemplary embodiment in the present disclosure.

### DETAILED DESCRIPTION

Exemplary embodiments of the present disclosure will now be described in detail with reference to the accompanying drawings.

Various types of electronic components are used in electronic devices, and among these electronic components, various types of coil components may be appropriately used for the purpose of removing noise and the like.

That is, in electronic devices, a coil component may be used as a power inductor, a high frequency (HF) inductor, a general bead, a high frequency bead (GHz Bead), a common mode filter, and the like.

### First Exemplary Embodiment

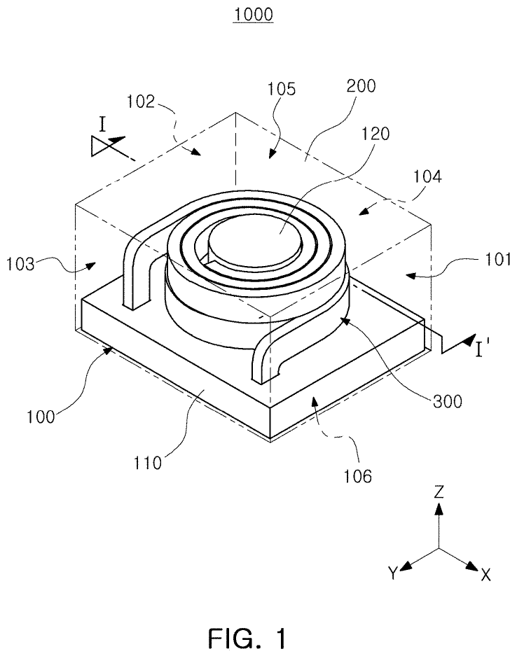

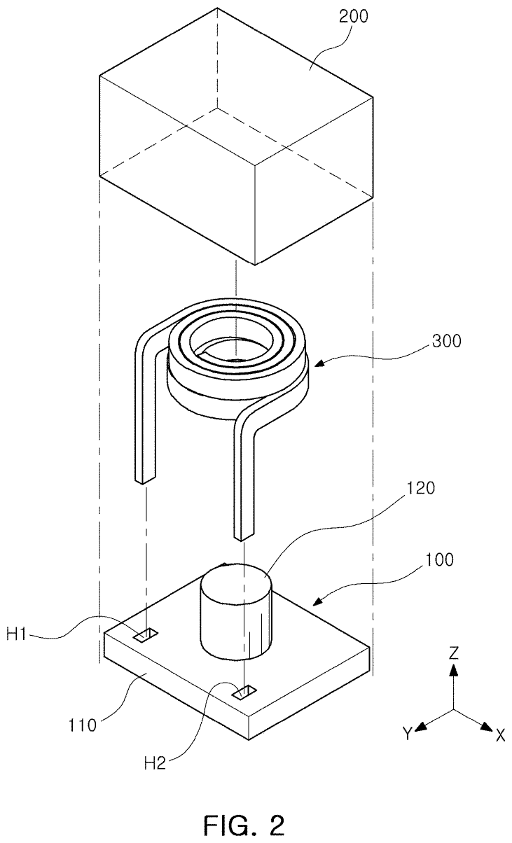

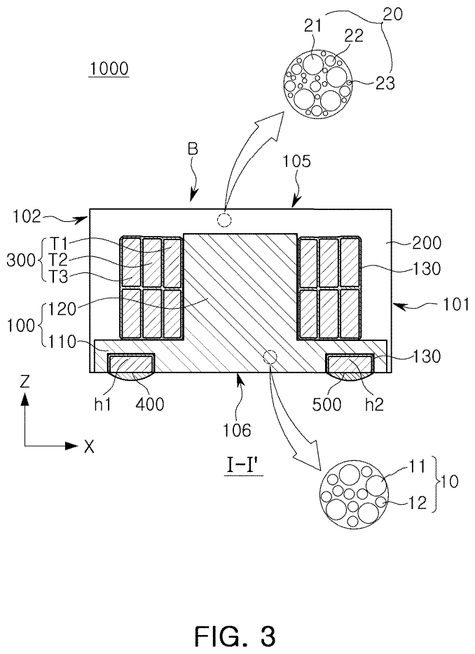

FIG. 1 is a diagram schematically illustrating a coil component according to a first exemplary embodiment in the present disclosure. FIG. 2 is an exploded perspective view of FIG. 1. FIG. 3 is a cross-sectional view of the coil component according to the first exemplary embodiment taken along line I-I′ of FIG. 1.

Referring to FIGS. 1 to 3, a coil component 1000 according to the first exemplary embodiment in the present disclosure includes a molded portion 100, a coil portion 300, a cover portion 200, and accommodating recesses h1 and h2, and further includes external electrodes 400 and 500.

A body B forms the exterior of the coil component 1000 according to the present exemplary embodiment, and the coil portion 300 is embedded therein. The body B includes the molded portion 100 and the cover portion 200. The molded portion 100 may include a core 120.

The body B may be formed in the shape of a hexahedron as a whole.

In FIGS. 1 and 2, the body B includes a first surface 101 and a second surface 102 facing each other in the length direction X, a third surface 103 and a fourth surface 104 facing each other in the width direction Y, and a fifth surface 105 and a sixth surface 106 facing each other in the thickness direction Z. Each of the first to fourth surfaces 101, 102, 103, and 104 of the body B corresponds to a wall surface of the body B connecting the fifth surface 105 and the sixth surface 106 of the body B. Hereinafter, both end surfaces of the body B may refer to the first surface 101 and the second surface 102 of the body B, and both side surfaces of the body B may refer to the third surface 103 and the fourth surface 104.

For example, the body B may be formed so that the coil component 1000 according to the present exemplary embodiment in which the external electrodes 400 and 500 to be described later are formed has a length of 2.0 mm, a width of 1.2 mm, and a thickness of 0.6 mm, but is not limited thereto.

Meanwhile, the body B includes the molded portion 100 and the cover portion 200, and the cover portion 200 is disposed on the molded portion 100 in FIG. 1 to surround all surfaces except a lower surface of the molded portion 100. Accordingly, the first to fifth surfaces 101, 102, 103, 104, and 105 of the body B are formed by the cover portion 200, and the sixth surface 106 of the body B is formed by the molded portion 100 and the cover portion 200.

The molded portion 100 has one surface and the other surface facing each other. One surface of the molded portion 100 is a surface corresponding to the lower surface of the molded portion 100, and refers to a region in which the accommodating recesses h1 and h2 to be described later are disposed. As will be described later, since the accommodating recesses h1 and h2 are machined inside the molded portion 100, bottom surfaces of the accommodating recesses h1 and h2 may be disposed in a region between one surface and the other surface of the molded portion 100. The molded portion 100 includes a support portion 110 and a core 120. The core 120 is disposed in a central portion of the other surface of the support portion 110 in the form of passing through the coil portion 300. For this reason, in the present disclosure, one surface and the other surface of the molded portion 100 are used to have the same meaning as the one surface and the other surface of the support portion 110, respectively.

The molded portion 100 may be formed by filling a mold for forming the molded portion 100 with a first magnetic metal particle 10. Alternatively, the molded portion 100 may be formed by filling a mold with a composite material including the first magnetic metal particle 10 and an insulating resin.

The coil portion 300 is embedded in the body B and manifests the characteristics of the coil component 1000. For example, when the coil component 1000 of the present exemplary embodiment is used as a power inductor, the coil portion 300 may store an electric field as a magnetic field to maintain an output voltage, thereby stabilizing power of the electronic device.

The coil portion 300 is disposed on the other surface of the molded portion 100. Specifically, the coil portion 300 is wound around the core 120 and is disposed on the other surface of the support portion 110.

The coil portion 300 is an air-core coil, and may be configured as a square coil. The coil portion 300 may be formed by winding a metal wire such as a copper wire having a surface coated with an insulating material in a spiral shape.

The coil portion 300 may include a plurality of layers. Each layer of the coil portion 300 may be formed in a planar spiral shape, and may have a plurality of turns. That is, the coil portion 300 may form an innermost turn T1, at least one intermediate turn T2, and an outermost turn T3 from the central portion of one surface of the molded portion 100 to the outside.

The cover portion 200 may be disposed on the molded portion 100 and the coil portion 300. The cover portion 200 covers the molded portion 100 and the coil portion 300. The cover portion 200 may be disposed on the support portion 110, the core 120, and the coil portion 300 of the molded portion 100, and then pressed to be coupled to the molded portion 100.

At least one of the molded portion 100 and the cover portion 200 includes magnetic metal particles. In the present disclosure, the magnetic metal particles may be interpreted to include both the first and second magnetic metal particles 10 and 20. In the case of an exemplary embodiment in the present disclosure, the molded portion 100 and the cover portion 200 include first and second magnetic metal particles 10 and 20, respectively.

The first and second magnetic metal particles 10 and 20 may include any one or more selected from the group consisting of iron (Fe), silicon (Si), chromium (Cr), cobalt (Co), molybdenum (Mo), aluminum (Al), and niobium (Nb), copper (Cu), and nickel (Ni). For example, the first and second magnetic metal particles 10 and 20 may be at least one or more of pure iron powder, Fe—Si-based alloy powder, Fe—Si—Al-based alloy powder, Fe—Ni-based alloy powder, Fe—Ni—Mo-based alloy powder, Fe—Ni—Mo—Cu-based alloy powder, Fe—Co-based alloy powder, Fe—Ni—Co-based alloy powder, Fe—Cr-based alloy powder, Fe—Cr—Si-based alloy powder, Fe—Si—Cu—Nb-based alloy powder, Fe—Ni—Cr-based alloy powder, and Fe—Cr—Al-based alloy powder.

The first and second magnetic metal particles 10 and 20 may be amorphous or crystalline. For example, the magnetic metal particles may be Fe—Si—B—Cr-based amorphous alloy powder, but is not necessarily limited thereto. The amorphous feature or crystallinity may be determined by, for example, X-ray diffraction spectrometry. Other methods and/or tools appreciated by one of ordinary skill in the art, even if not described in the present disclosure, may also be used.

At least one of the first and second magnetic metal particles 10 and 20 may include first to third particles having different medians particle sizes. The first and second magnetic metal particles 10 and 20 may differ from each other in terms of, for example, the particles constituting the magnetic metal particle.

For example, in the coil component 1000 according to the first exemplary embodiment, the second magnetic metal particles 20 may include first to third particles 21, 22, and 23 having different median particle sizes. Meanwhile, the first magnetic metal particles 10 may include first and second particles 11 and 12 having different median particle sizes.

In the present disclosure, the particle size of each of the first particles 11 and 21, the second particles 12 and 22 and the third particles 13 and 23 refers to an average value of particle sizes of particles measured in a plurality of cross-sections cut to a plurality of planes at equal intervals.

For example, in the present disclosure, the average value of the particle sizes may refer to an average value of particle sizes calculated using an image analysis program (LAS X Grain Expert of Leica Microsystems) after photographing ten points of cross-sections in X-Z directions passing through the center of the coil components 1000 and 2000 at equal intervals in the X direction with a scanning electron microscope (SEM).

Meanwhile, in the present disclosure, the first and second magnetic metal particles 10 and 20 may have a spherical or substantially spherical shape, but are not limited thereto.

Therefore, when the first and second magnetic metal particles 10 and 20 have an arbitrary shape that does not maintain a spherical shape, the aforementioned particle size may be replaced with a Feret diameter to be described later, and interpreted.

Ferret diameter is also known as caliper diameter, which may refer to a distance between two tangent lines on opposite surfaces of a particle profile, parallel to a partially fixed direction.

Also, a maximum Ferret diameter Fmax may refer to a maximum distance between pairs of tangents to a particle projection in the partially fixed direction.

In the present disclosure, if the first and second magnetic metal particles 10 and 20 do not maintain a spherical shape, the description of the particle size of the first and second magnetic metal particles 10 and 20 described above may be interpreted as being replaced with the ferret diameter of the first and second magnetic metal particles 10 and 20.

In addition, the average value of the particle sizes may also be replaced with an average value of the Feret diameter to be interpreted. For example, in the present disclosure, the average value of the Feret diameters may refer to an average value of Feret diameters calculated using an image analysis program (LAS X Grain Expert of Leica Microsystems) after photographing ten points of cross-sections in X-Z directions passing through the center of the coil components 1000 and 2000 at equal intervals in the X direction with a scanning electron microscope (SEM).

At least one of the molded portion 100 and the cover portion 200 may include three or more types of magnetic metal particles. As an example, in the case of the first exemplary embodiment in the present disclosure, the second magnetic metal particles 20 of the cover portion 200 include three types of magnetic metal particles 21, 22, and 23, and first magnetic metal particles 10 of the molded portion 100 include two types of magnetic metal particles 11 and 12. However, the present disclosure is not limited thereto, and both the molded portion 100 and the cover portion 200 may include three or more types of magnetic metal particles.

Here, the different types of magnetic metal particles mean that the magnetic metal particles are distinguished from each other by any one of particle size, composition, crystallinity, and shape, and in the case of the coil component in the first exemplary embodiment in the present disclosure, the first particles 11 and 21, the second particles 12 and 22, and the third particles 23 inside the first and second magnetic metal particles 10 and 20 are distinguished from each other by the particle size.

The insulating resin may include, but is not limited to, epoxy, polyimide, liquid crystal polymer, and the like alone or in combination.

The first and second accommodating recesses h1 and h2 are formed to be spaced apart from each other on one surface of the molded portion 100, and both ends of the coil portion 300 to be described later are disposed in the first and second accommodating recesses h1 and h2. For example, referring to FIG. 3, the first and second accommodating recesses h1 and h2 are each formed on one surface of the molded portion 100 and are spaced apart from each other in the length direction X. The first and second accommodating recesses h1 and h2 may be disposed outside a region corresponding to the core 120 on one surface of the molded portion 100, but is not limited thereto.

Each of the first and second accommodating recesses h1 and h2 may be formed to extend in one direction on one surface of the molded portion 100, but is not limited as long as it has a structure that may effectively expose both ends of the coil portion 300.

In an exemplary embodiment in the present disclosure, since the body B is a region including the molded portion 100 and the cover portion 200, one surface of the body B refers to one surface of a region including the molded portion 100 and the cover portion 200. The coil portion 300 includes first and second lead portions 331 and 332 drawn out to the outside, the first lead portion is disposed in the first accommodating recess h1 and the second lead portion is disposed in the second accommodating recess h2, to be spaced apart from each other. The first and second accommodating recesses h1 and h2 are regions in which both ends of the coil portion 300 are drawn out to the external electrodes 400 and 500, and thus the first and second accommodating recesses h1 and h2 may be formed on one surface of the body B and spaced apart from each other to correspond to the first and second external electrodes 400 and 500, respectively.

As an example, through recesses H1 and H2 may be formed by a mold when the molded portion 100 is formed, and the first and second accommodating recesses h1 and h2 may be formed in the molded portion 100 in a process of forming the cover portion 200 by laminating and compressing a magnetic sheet including magnetic metal particles. Protrusions corresponding to the through recesses H1 and H2 may be formed in a mold for forming the molded portion 100, so that the through recesses H1 and H2 may be formed in the molded portion 100 manufactured in a form corresponding to the shape of the mold. Also, the first and second accommodating recesses h1 and h2 may be formed in the process of forming the cover portion 200 on the molded portion 100, rather than being formed in the process of forming the molded portion 100. That is, both ends of the coil portion 300 protruding from one surface of the molded portion 100 through the through recesses H1 and H2 of the molded portion 100 may be embedded inside the molded portion 100 during the process of compressing a magnetic sheet. Accordingly, the first and second accommodating recesses h1 and h2 may be formed on one surface of the molded portion 100. Alternatively, the first and second accommodating recesses h1 and h2 and the through recesses H1 and H2 may be formed in the process of forming the molded portion 100 using a mold. In this case, protrusions corresponding to the first and second accommodating recesses h1 and h2 and the through recesses H1 and H2 may be formed in the mold used to form the molded portion 100.

Referring to FIG. 2, both ends of the coil portion 300 may pass through one surface of the molded portion 100 and be disposed in the first and second accommodating recesses h1 and h2, respectively. Since the shape in which the ends of the coil portion 300 are disposed in the accommodating recesses h1 and h2 is not limited, widths of the first and second accommodating recesses h1 and h2 may be the same as or may be different from widths of the through recesses H1 and H2.

Both ends of the coil portion 300 are exposed to one surface of the molded portion 100, that is, the sixth surface 106 of the body B. Both ends of the coil portion 300 exposed to one surface of the molded portion 100 are disposed in first and second accommodating recesses h1 and h2 formed to be spaced apart from each other on the sixth surface 106 of the body B.

Referring to FIGS. 2 and 3, both ends of the coil portion 300 may pass through the support portion 110 of the molded portion 100 to be exposed to one surface of the support portion 110. Although not specifically illustrated, both ends of the coil portion 300 have the same thickness as that of the coil portion 300, and thus, both ends of the coil portion 300 may protrude from one surface of the support portion 110 as much as it corresponds to the thickness of the coil portion 300. However, since the protruding ends may also be polished in the process of polishing an opening of a plating resist for forming the external electrodes 400 and 500 to be described later, the ends of the coil portion 300 exposed to one surface of the support portion 110 may be substantially smaller than the thickness of the coil portion 300.

Meanwhile, a plurality of the first and second magnetic metal particles 10 and 20 may be disposed in an insulating resin, and at least one of the first and second magnetic metal particles 10 and 20 may include first to third particles 11, 21, 12, 22, 13, and 23 having different average particle sizes.

Meanwhile, the first particles 11 and 21 may refer to particles having a particle size of 5 μm to 61 μm, the second particles 12 and 22 may refer to particles having a particle size of 0.6 μm to 4.5 μm, and the third particles 13 and 23 may refer to particles having a particle size of 10 nm to 900 nm.

In addition, the first particles 11 and 21 may be coarse powder, the second particles 12 and 22 may be fine powder, and the third particles 13 and 23 may be ultrafine powder, and when a median of particle sizes of the first particles 11 and 21 is D1, a median of particle sizes of the second particles 12 and 22 is D2, and a median of particle sizes of the third particles 13 and 23 is D3, D1>D2>D3 may be satisfied.

Here, the medians D1, D2 and D3 may refer to values located at the most center when particle sizes of the plurality of first particles 11 and 21, the second particles 12 and 22, and the third particles 13 and 23 are measured and then aligned in the order of their sizes, and refers to d50 in the particle size analysis field. d50 refers to a corresponding particle size when a cumulative percentage reaches 50% and is also called a median particle size

Here, D1 may be 5 μm to 35 μm, D2 may be 1 μm to 4 μm, and D3 may be 10 nm to 900 nm, but are not limited thereto.

The first particles 11 and 21 may include an amorphous Fe component, for example, may include an Fe-based amorphous alloy. Specifically, the first particles 11 and 21 may include any one or more selected from the group consisting of iron (Fe), silicon (Si), chromium (Cr), boron (B) and nickel (Ni) and may be, for example, a Fe—Si—B—Cr-based amorphous metal, but is not necessarily limited thereto. Meanwhile, in some cases, the first particles 11 and 21 may include crystalline materials like second particles 12 and 22 and third particles 13 and 23 to be described later.

The second particles 12 and 22 and the third particles 13 and 23 may include a crystalline form of an Fe component, for example, pure iron or carbonyl iron powder (CIP), among the materials of the magnetic metal particles described above.

Meanwhile, in the case of the ultrafine third particles 13 and 23, Fe₃O₄ may be included in the third particles 13 and 23 during the process of manufacturing to have an ultrafine size. Since the third particles 13 and 23 include the magnetic material Fe₃O₄, magnetic properties may be improved in the three-component system configuration further including the third particles 13 and 23.

Referring to FIG. 3, a cross-sectional view of the coil component 1000 according to the first exemplary embodiment taken along line I-I′ of FIG. 1 is illustrated.

Referring to FIG. 3, in the case of the coil component 1000 according to the first exemplary embodiment in the present disclosure, the first magnetic metal particles 10 included in the molded portion 100 include two types of magnetic metal particles 11 and 12, and the second magnetic metal particles 20 included in the cover portion 200 include three types of magnetic metal particles 21, 22, and 23. That is, a three-component system may be applied to the second magnetic metal particles 20 of the cover portion 200, and a two-component system may be applied to the first magnetic metal particles 10 of the molded portion 100. In some embodiments, the two-component system may be free of the third particle, as determined using, for example, electron microscopy such as SEM and TEM. Other methods and/or tools appreciated by one of ordinary skill in the art, even if not described in the present disclosure, may also be used.

According to the first exemplary embodiment of FIG. 3, the molded portion 100 may include the first and second particles 11 and 12 and may be free of the third particle, and the cover portion 200 may include the first to third particles 21, 22 and 23. If the thickness of the cover portion 200 is reduced to reduce an overall thickness of the coil component 1000, the thin cover portion 200 may be damaged during a process when a compression pressure is increased. Therefore, as the thickness of the cover portion 200 decreases, the pressure applied to the cover portion 200 also needs to be reduced, but in this case, non-filling of the magnetic metal particles in the cover portion 200 may occur.

TABLE 1

| | Magnetic | | | Filling rate |
|---|---|---|---|---|
| | permeability | Q | Rs | (%) |
| Two-component | 34.3 | 52.5 | 445.96 | 83.55 |
| system | | | | |
| Three-component | 40.00 | 47.70 | 557.22 | 85.46 |
| system | | | | |

The data based on the experiment of Table 1 show different filling rates in the case of including the magnetic metal particles of the two-component system and in the case of including the magnetic metal particles of the three-component system when the same pressure is applied. As a result, it can be seen that the filling rate of the magnetic metal particles may be improved under the same pressure, and thus magnetic permeability also increases when the three-component system is used. In the meantime, Rs stands for a series resistance of an inductor and may be the sum of Rac (AC resistance) and Rdc (DC resistance). Rs may be measured by an impedance analyzer. An impedance analyzer may be used to measure the magnetic permeability and the Q value. Other methods and/or tools appreciated by one of ordinary skill in the art, even if not described in the present disclosure, may also be used. The filling rate may be obtained by using an image analysis program after photographing, for example, ten regions of cross-sections in X-Z directions passing through the center of the coil component at equal intervals in the X and Z directions with a scanning electron microscope (SEM). Other methods and/or tools appreciated by one of ordinary skill in the art, even if not described in the present disclosure, may also be used.

In the case of the coil component 1000 according to the first exemplary embodiment in the present disclosure, the second magnetic metal particles 20 in the cover portion 200 have the three-component system structure including the first to third particles 21, 22, and 23, and thus, the cover portion 200 may be filled with a sufficient content of the magnetic metal particles even when a lower pressure is applied.

In addition, since the magnetic metal particles in the cover portion 200 have a three-component system structure including the third particles 23 and the third particles 23 include Fe₃O₄ as a magnetic substance, the magnetic properties in the cover portion 200 additionally including the third particles 23 may be improved and high magnetic permeability may be secured.

Therefore, even when a relatively high pressure is applied to the molded portion 100 side and a relatively low pressure is applied to the cover portion 200 side, the coil component 1000 having a thin thickness of a desired size may be manufactured in a state in which a high filling rate and magnetic permeability are secured.

Meanwhile, as described above, since the third particle 23 may include Fe₃O₄, Fe₃O₄ may be detected in the cover portion 200 in the coil component 1000 according to the first exemplary embodiment.

The external electrodes 400 and 500 may be disposed to be spaced apart from each other on one surface of the body B, that is, the sixth surface 106. Specifically, the external electrodes 400 and 500 are spaced apart from each other on one surface of the molded portion 100 and may be connected to both ends of the coil portion 300 disposed in the first and second accommodating recesses h1 and h2, respectively.

Since both ends of the coil portion 300 are disposed along the bottom surfaces of the first and second accommodating recesses h1 and h2, and the external electrodes 400 and 500 are applied along both ends of the coil portion 300, so that the external electrodes may be formed to correspond to the shape of the first and second accommodating recesses h1 and h2.

As an example, the external electrodes 400 and 500 may be formed by applying a conductive resin including a conductive powder such as silver (Ag) on the first and second accommodating recesses h1 and h2.

The external electrodes 400 and 500 may be formed of a conductive material such as copper (Cu), aluminum (Al), silver (Ag), tin (Sn), gold (Au), nickel (Ni), lead (Pb), chromium (Cr), titanium (Ti), or alloys thereof, but are not limited thereto.

The external electrodes 400 and 500 may be formed in a single-layer or multi-layer structure. According to the present exemplary embodiment, the external electrodes 400 and 500 may include a first layer connected to both ends of the coil portion 300 and disposed to be in contact with both ends of the coil portion 300 and a second layer covering the first layer. As an example, the first layer may be formed of a conductive resin including silver (Ag) powder, but is not limited thereto and may be formed of a pre-plating layer including copper (Cu). Although not specifically illustrated, the second layer may be disposed on the first layer to cover the first layer. The second layer may include nickel (Ni) and/or tin (Sn). The second layer may be formed by electroplating, but is not limited thereto.

Meanwhile, the coil component 1000 according to the present exemplary embodiment may further include an insulating layer 130 surrounding a surface of the coil portion 300. A method of forming the insulating layer 130 is not limited, but for example, the insulating layer 130 may be formed by chemical vapor deposition of parylene resin or the like on the surface of the coil portion 300 or may be formed through a known method such as a screen printing method, a process through photoresist (PR) exposure and development, spray application, or a dipping process.

The insulating layer 130 is not particularly limited as long as it may be formed as a thin film, but may include, for example, photoresist (PR), an epoxy-based resin, or the like.

Meanwhile, although not shown, the coil component 1000 according to the present exemplary embodiment may further include an additional insulating layer in a region of the sixth surface 106 of the body B except for the region in which the external electrodes 400 and 500 are disposed. When forming the external electrodes 400 and 500 by electroplating, the additional insulating layer may be used as a plating resist, but is not limited thereto. In addition, the additional insulating layer may be disposed on at least a portion of the first to fifth surfaces 101, 102, 103, 104, and 105 of the body B to prevent an electrical short between other electronic components and the external electrodes 400 and 500.

Meanwhile, in FIGS. 1 to 5, it is illustrated that the through recesses H1 and H2 pass through the molded portion 100 from the inside of the molded portion 100, but this is only an example. That is, as a modified example of the present exemplary embodiment, the through recesses H1 and H2 may communicate with the first and second accommodating recesses h1 and h2 formed on a side surface of the molded portion 100 and disposed on one surface of the molded portion 100. In this case, both ends of the coil portion 300 may be disposed along a side surface of the molded portion 100 and one surface of the molded portion 100.

### Second Exemplary Embodiment

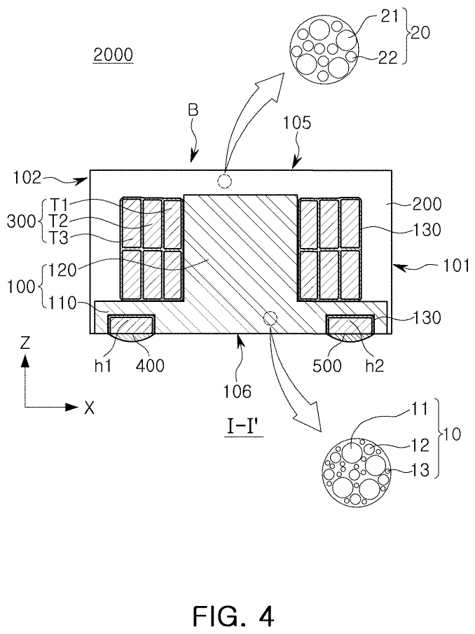

FIG. 4 is a cross-sectional view of a coil component 2000 according to a second exemplary embodiment in the present disclosure taken along line I-I′ of FIG. 1.

Referring to FIG. 4, in the coil component 2000 according to the second exemplary embodiment in the present disclosure, a structure of the magnetic metal particles in the molded portion 100 and the cover portion 200 is different, compared with the coil component 1000 according to the first exemplary embodiment in the present disclosure. Therefore, in describing the present exemplary embodiment, only the structure of the magnetic metal particle, which is different from the first exemplary embodiment in the present disclosure, will be described. The description of the first exemplary embodiment in the present disclosure may be applied as it is to the rest of the configuration of the present exemplary embodiment.

Referring to FIG. 4, in the coil component 2000 according to the second exemplary embodiment, the first magnetic metal particles 10 in the molded portion 100 may include the first to third particles 11, 12, and 13 having different median particle sizes. Meanwhile, the second magnetic metal particles 20 in the cover portion 200 may include first and second particles 21 and 22 having different median particle sizes.

In the case of the coil component 2000 according to the second exemplary embodiment, the first magnetic metal particles 10 in the molded portion 100 may include a three-component system including the first to third particles 11, 12, and 13 having different average particle sizes, and the second magnetic metal particles 20 in the cover portion 200 may include a two-component system including first and second particles 21 and 22 having different average particle sizes and may be free of the third particle.

The description of the first to third particles 11, 21, 12, 22, 13, and 23 and the particle sizes thereof may be applied as it is to the description of the coil component 1000 according to the first exemplary embodiment.

In the case of the coil component 2000 according to the second exemplary embodiment, a problem that a high compression pressure cannot be secured due to damage to the core 120 and the molded portion 100 when the area of the core 120 is reduced due to an increase in the number of turns of the coil portion 300 may be prevented in advance.

That is, by applying a three-component system including the first to third particles 11, 12, and 13 to the molded portion 100, the magnetic metal particles in the molded portion 100 may be filled with a sufficient content even at a lower pressure, thereby securing a high filling rate. In addition, since the magnetic metal particles in the molded portion 100 have a three-component structure including the third particles 13 and the third particles 13 includes the magnetic material Fe₃O₄, magnetic properties may be improved and magnetic permeability may be secured in the molded portion 100 additionally including the third particles 13.

Therefore, even when a relatively high pressure is applied to the cover portion 200 side and a relatively low pressure is applied to the molded portion 100 side, the coil component 2000 having a low thickness of a desired size may be manufactured in a state in which a high filling rate and magnetic permeability are secured.

Meanwhile, as described above, since the third particle 13 may include Fe₃O₄, Fe₃O₄ may be detected in the molded portion 100 in the coil component 2000 according to the second exemplary embodiment.

For other overlapping configurations, the description of the first exemplary embodiment in the present disclosure may be applied as it is.

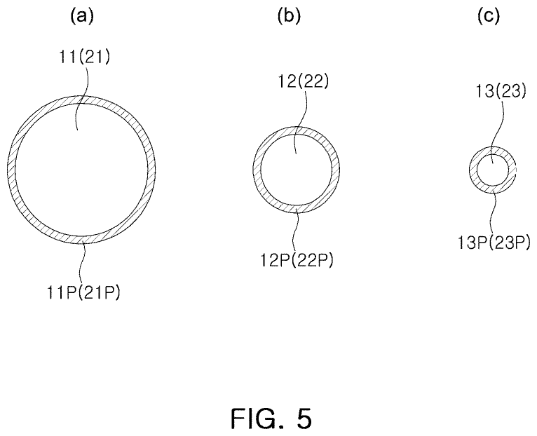

FIG. 5 is an enlarged cross-sectional view illustrating magnetic metal particles applied to the first and second exemplary embodiments of the present disclosure.

As shown in FIG. 5, coating films 11P, 21P, 12P, 22P, 13P, and 23P may be formed on the surface of the magnetic metal particles to prevent leakage of current, more completely insulate the magnetic metal particles, and protect the magnetic metal particles. The first to third particles 11, 21, 12, 22, 13, and 23 in the coil components 1000 and 2000 according to the first and second exemplary embodiments may have the first to third coating films 11P, 21P, 12P, 22P, 13P, and 23P formed on surfaces thereof as shown in FIG. 5.

The first to third coating films 11P, 21P, 12P, 22P, 13P, and 23P may be formed by oxidizing the first to third particles 11, 21, 12, 22, 13, and 23, respectively.

Accordingly, when the first to third particles 11, 21, 12, 22, 13, and 23 are iron-based alloy particles, the first to third coating films 11P, 21P, 12P, 22P, 13P, and 23P may include Fe-based oxide. In addition, the first to third coating films 11P, 21P, 12P, 22P, 13P, and 23P may use phosphate or the like in order to increase the contribution to the magnetic properties of the coil components 1000 and 2000. As another example, in addition to phosphate, Fe₂O₃ or NiZnCu ferrite, NiZn ferrite, or the like, which may be expected to contribute to magnetic properties, may be used. In addition, oxide such as MgO or Al₂O₃ may also be used.

For example, the first and second coating films 11P, 21P, 12P, and 22P formed on the surfaces of the first particles 11 and 21 and the second particles 12 and 22 may be films formed of a material such as FeO or Fe₂O₃.

Meanwhile, the third particles 13 and 23 described above may include Fe₃O₄ therein, and accordingly, the third coating films 13P and 23P formed on the surface of the third particles 13 and 23 may include Fe₃O₄ in addition to FeO or Fe₂O₃.

In addition, the first to third coating films 11P, 21P, 12P, 22P, 13P, and 23P may be films using ferrite partially substituted with metal ions such as Ni, Cu, Zn, in order to maximize the effect of magnetic properties.

Meanwhile, a particle size of each of the first to third particles 11, 21, 12, 22, 13, and 23 may refer to a numerical value including a thickness of the first to third coating films 11P, 21P, 12P, 22P, 13P, and 23P.

### Third Exemplary Embodiment

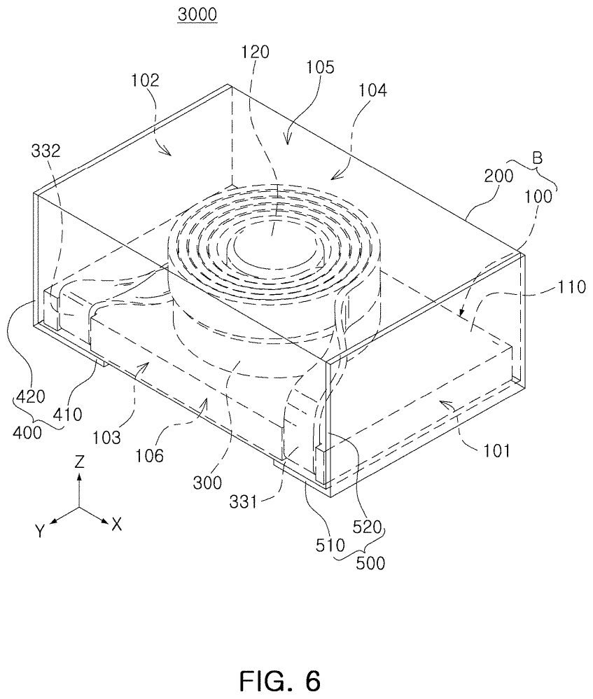

FIG. 6 is a view schematically illustrating a coil component according to a third exemplary embodiment in the present disclosure.

In a coil component 3000 according to the third exemplary embodiment in the present disclosure, a method of drawing the coil portion 300 to the outside of the body B is different from that of the coil components 1000 and 2000 according to the first and second exemplary embodiments. Accordingly, in the description of the third exemplary embodiment below, only a structure different from that of the first exemplary embodiment will be described, and the description of the first exemplary embodiment may be equally applied to other overlapping configurations.

A support portion 110 of the coil component 3000 according to the third exemplary embodiment in the present disclosure may include first and second accommodating recesses h1 and h2 formed to have a shape corresponding to first and second lead portions 331 and 332 of a winding coil 300 to accommodate the first and second lead portions 331 and 332.

In the coil component 3000 according to the third exemplary embodiment, the positions of the first and second accommodating recesses h1 and h2 are different from those of the coil components 1000 and 2000 according to the first and second exemplary embodiments. In the coil component 3000 according to the third exemplary embodiment, the first and second accommodating recess portions h1 and h2 are respectively formed in a thickness direction (T direction) on one side surface of the support portion 110 and may extend in a width direction (W direction) on the other surface 106 of the support portion 110. The first and second accommodating recesses h1 and h2 may be disposed parallel to each other in a length direction (L direction). Accordingly, when a magnetic material is included in the cover portion 200, the same component as the magnetic material of the cover portion 200 may be disposed in the first and second accommodating recesses h1 and h2.

The first and second lead portions 331 and 332 are accommodated along the first and second accommodating recesses h1 and h2 of the support portion 110, respectively, and one end is connected to a winding part, and the other end is exposed to the sixth surface 106 of the body B and connected to the first and second external electrodes 400 and 500, respectively.

Regarding the other overlapping configurations, the descriptions of the coil portions according to the first and second exemplary embodiments may be equally applied.

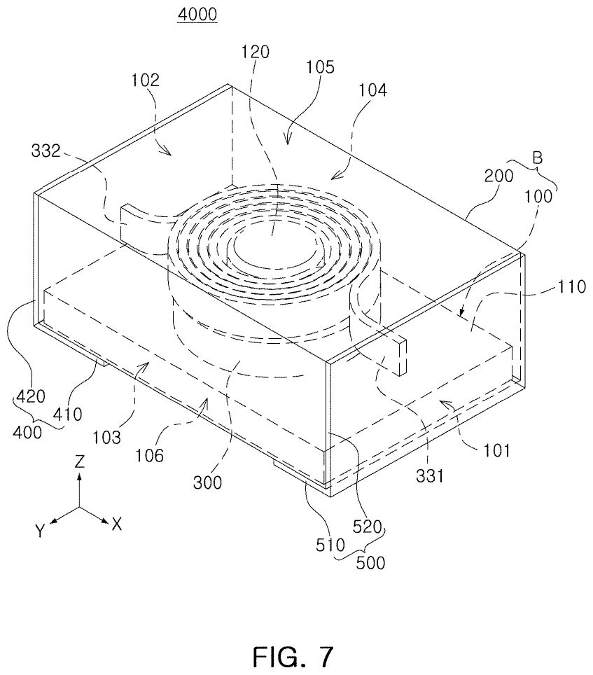

FIG. 7 is a view schematically illustrating a coil component according to a fourth exemplary embodiment in the present disclosure.

A separate accommodating recess may not be formed in the support portion 110 of the coil component 4000 according to the fourth exemplary embodiment. Accordingly, the first and second lead portions 331 and 332 of the winding coil 300 may be exposed to opposite side surfaces of the body B, respectively. For example, the first lead portion 331 may be exposed to the first surface 101 of the body B, and the second lead portion 332 may be exposed to the second surface 102 of the body B and may be connected to the first and second external electrodes 400 and 500, respectively.

Regarding the other overlapping configurations, the description of the coil component according to the third exemplary embodiment may be equally applied.

As an effect of the present disclosure, a coil component in which a body of a coil component having a low thickness is formed without destroying the body may be provided.

As another effect of the present disclosure, a coil component in which a body is formed even at low pressure may be provided.

As another effect of the present disclosure, a coil component in which a filling rate of magnetic particles in a body is secured even at low pressure may be provided.

While exemplary embodiments have been shown and described above, it will be apparent to those skilled in the art that modifications and variations could be made without departing from the scope of the present disclosure as defined by the appended claims.

What is claimed is:

1. A coil component comprising:
a body including a molded portion including a first magnetic metal particle and a cover portion disposed on one surface of the molded portion and including a second magnetic metal particle; and
a coil portion disposed between the one surface of the molded portion and the cover portion and embedded in the body,
wherein at least one of the first and second magnetic metal particles includes first to third particles having different medians (d50) of particle sizes.

2. The coil component of claim 1, wherein D1>D2>D3 in which D1 is the median (d50) of the particle size of the first particle, D2 is the median (d50) of the particle size of the second particle, and D3 is the median (d50) of the particle size of the third particle.

3. The coil component of claim 2, wherein
the first magnetic metal particle includes the first to third particles, and
the second magnetic metal particle includes the first and second particles.

4. The coil component of claim 2, wherein
the second magnetic metal particle includes the first to third particles, and
the first magnetic metal particle includes the first and second particles.

5. The coil component of claim 2, wherein the first particle includes an amorphous Fe component.

6. The coil component of claim 5, wherein the second and third particles include a crystalline Fe component.

7. The coil component of claim 3, wherein the second and third particles include a crystalline Fe component.

8. The coil component of claim 4, wherein the second and third particles include a crystalline Fe component.

9. The coil component of claim 6, wherein the third particle includes Fe₃O₄ therein.

10. The coil component of claim 2, wherein
the particle size of the first particle is 5 μm to 61 μm,
the particle size of the second particle is 0.6 μm to 4.5 μm, and
the particle size of the third particle is 10 nm to 900 nm.

11. The coil component of claim 2, wherein
D1 is 5 μm to 35 μm,
D2 is 1 μm to 5 μm, and
D3 is 10 nm to 900 nm.

12. The coil component of claim 11, wherein
the first magnetic metal particle includes the first to third particles, and
the second magnetic metal particle includes the first and second particles.

13. The coil component of claim 11, wherein
the second magnetic metal particle includes the first to third particles, and
the first magnetic metal particle includes the first and second particles.

14. The coil component of claim 11, wherein the first particle includes an amorphous Fe component.

15. The coil component of claim 11, wherein the second and third particles include a crystalline Fe component.

16. The coil component of claim 15, wherein the second and third particles include a crystalline Fe component.

17. The coil component of claim 12, wherein the second and third particles include a crystalline Fe component.

18. The coil component of claim 16, wherein the third particle includes Fe₃O₄ therein.

19. The coil component of claim 9, further comprising first to third coating films coated on surfaces of the first to third particles, respectively.

20. The coil component of claim 18, further comprising first to third coating films coated on surfaces of the first to third particles, respectively.

21. The coil component of claim 19, wherein
the first and second coating films include Fe₂O₃, and
the third coating film includes Fe₃O₄.

22. The coil component of claim 20, wherein
the first and second coating films include Fe₂O₃, and
the third coating film includes Fe₃O₄.

23. The coil component of claim 2, further comprising external electrodes disposed on outer surfaces of the body and electrically connected to the coil portion.

24. The coil component of claim 2, further comprising a coating film surrounding a surface of each of a plurality of turns of the coil portion.

25. The coil component of claim 11, further comprising external electrodes disposed on outer surfaces of the body and electrically connected to the coil portion.

26. The coil component of claim 11, further comprising a coating film surrounding a surface of each of a plurality of turns of the coil portion.

27. A coil component comprising:
a body including a molded portion including a first magnetic metal particle and a cover portion disposed on one surface of the molded portion and including a second magnetic metal particle; and
a coil portion disposed between the one surface of the molded portion and the cover portion and embedded in the body,
wherein at least one of the first and second magnetic metal particles includes a first particle having a particle size of 5 μm to 61 μm, a second particle having a particle size of 0.6 μm to 4.5 μm, and a third particle having a particle size of 10 nm to 900 nm.

28. The coil component of claim 27, wherein the first to third particles have different medians (d50) of particle sizes, and one of the first and second magnetic metal particles includes the first to third particles, and the other includes the first and second particles.

29. The coil component of claim 28, wherein the third particle includes Fe₃O₄ therein.

30. The coil component of claim 26, wherein
D1>D2>D3 in which D1 is the median (d50) of the particle size of the first particle, D2 is the median (d50) of the particle size of the second particle, and D3 is the median (d50) of the particle size of the third particle,
wherein D1 is 5 μm to 35 μm,
D2 is 1 μm to 5 μm, and
D3 is 10 nm to 900 nm.

31. The coil component of claim 30, wherein the third particle includes Fe₃O₄ therein.

32. A coil component comprising:
a body including a molded portion including a first magnetic metal particle and a cover portion disposed on one surface of the molded portion and including a second magnetic metal particle, wherein the first magnetic metal particle is different from the second magnetic metal particle, the first magnetic metal particle or the second magnetic metal particle includes first to third particles having different medians (d50) of particle sizes, and the other magnetic metal particle includes the first and second particles; and
a coil portion disposed between the one surface of the molded portion and the cover portion and embedded in the body.

33. The coil component of claim 32, wherein the first magnetic metal particle includes the first to third particles.

34. The coil component of claim 33, wherein the second magnetic metal particle is free of the third particle.

35. The coil component of claim 32, wherein the second magnetic metal particles include the first to third particles.

36. The coil component of claim 35, wherein the first magnetic metal particle is free of the third particle.

37. The coil component of claim 32, wherein
the particle size of the first particle is 5 μm to 61 μm,
the particle size of the second particle is 0.6 μm to 4.5 μm, and
the particle size of the third particle is 10 nm to 900 nm.

38. The coil component of claim 32, wherein the third particle includes Fe₃O₄ therein.
